(19) United States
(12) Patent Application Publication
(10) Pub. No.: US 2009/0208168 A1
(43) Pub. Date: Aug. 20, 2009

(54) CONNECTOR, OPTICAL TRANSMISSION MODULE AND OPTICAL-ELECTRICAL TRANSMISSION MODULE

(75) Inventors: Yoshihiro ISHIKAWA, Atsugi-shi (JP); Shinichi ASANO, Hitachinaka-shi (JP); Tomoe TOYODA, Tokyo (JP); Takao INOUE, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tama-shi (JP)

(21) Appl. No.: 12/388,681

(22) Filed: Feb. 19, 2009

(30) Foreign Application Priority Data
Feb. 20, 2008 (JP) 2008-038596

(51) Int. Cl. G02B 6/42; H01R 4/48; G02B 6/12; H01R 13/66

(52) U.S. Cl. 385/14; 439/816; 385/92; 439/620.22

(57) ABSTRACT

A connector, including: a receptacle including a projecting terminal electrically connected to an external terminal; and a plug including a contact point with an elastic section to elastically deform when the projecting terminal is inserted therein to be electrically connected to the projecting terminal by resilience.

### BACKGROUND OF THE INVENTION

1. Field of the Invention

The present invention relates to a connector, optical transmission module and optical-electrical transmission module.

2. Description of Related Art

Circuits on a plurality of substrates in a mobile terminal such as a cellular phone, laptop computer, digital camera and game machine are connected to one another by a film cable or optical transmission waveguide film to send and receive an electrical signal or optical signal. As shown in FIG. 18, the optical transmission waveguide film 100, etc., is connected to optical transmission modules 101 and 101 placed on each of the substrates (not shown) to connect circuits (not shown) on the substrates to each other.

As for the connector or optical transmission module for connecting the circuits on the substrates and the film cable or optical transmission waveguide film, for example, in an example of an optical transmission module shown in FIG. 18, as shown in FIG. 19A, an optical signal sending and receiving section, amplifying section and communication control section cased by an upper case 211 and a lower case 212 are mounted by fitting the above into the fitting section 120 of the connector main body 110.

When mounting is performed, as shown in FIG. 19B, by allowing the socket contact section 121 provided in the connector main body 110 to be in contact from the side with the connection terminal 213 provided on a side face of the lower case 212, the optical transmission waveguide film 100 is electrically connected to an external terminal 122 through the optical signal sending and receiving section, etc., the connection terminal 213 and the socket contact section 121 to be connected to the circuit (not shown) on the substrate. Incidentally, FIG. 19A shows an example where the optical signal sending and receiving section, amplifying section and communication control section of the optical transmission module 101 are each in a case separately. See Japanese Patent Application Laid-Open Publication No. 2007-286553 and Japanese Patent Application Laid-Open Publication No. 2007-157363.

The optical transmission module 101 as shown in FIG. 18, etc. can be manufactured in a compact form such that a length in a longitudinal direction is about 10 mm and a height from the substrate face is about 2 to 3 mm. However, in the field of mobile terminals, the size being smaller and thinner is strongly demanded, and the optical transmission module, etc. being even smaller and shorter in height is also demanded, however in the optical transmission module of the type shown in FIG. 18, etc., it is not necessarily easy to make the size smaller and shorter in height.

Therefore, in order to make the connector and the optical transmission module even smaller and shorter in height, the structure of the connector and the connector section of the optical transmission module need to be based on a new idea.

### SUMMARY OF THE INVENTION

It is, therefore, a main object of the present invention to provide a connector which can be smaller and shorter in height and to provide an optical transmission module and optical-electrical transmission module using such a connector.

According to an aspect of the present invention, there is provided a connector, including:

a receptacle including a projecting terminal electrically connected to an external terminal; and

a plug including a contact point with an elastic section to elastically deform when the projecting terminal is inserted therein to be electrically connected to the projecting terminal by resilience.

According to another aspect of the present invention, there is provided an optical transmission module including the connector including:

a receptacle including a projecting terminal electrically connected to an external terminal; and

a plug including a contact point with an elastic section to elastically deform when the projecting terminal is inserted therein to be electrically connected to the projecting terminal by resilience, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film.

According to another aspect of the present invention, there is provided an optical-electrical transmission module including the connector including:

a receptacle including a projecting terminal electrically connected to an external terminal;

a plug including a contact point with an elastic section to elastically deform when the projecting terminal is inserted therein to be electrically connected to the projecting terminal by resilience; and

an FPC for electrical signal transmission, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film.

According to another aspect of the present invention, there is provided an optical-electrical transmission module including the connector including:

a receptacle including a projecting terminal electrically connected to an external terminal;

a plug including a contact point with an elastic section to elastically deform when the projecting terminal is inserted therein to be electrically connected to the projecting terminal by resilience; and

an FPC for electrical signal transmission, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film, and

the FPC for electrical signal transmission is formed thinner than the circuit substrate.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, wherein:

FIG. 1 is an exploded perspective view showing a structure such as a receptacle and plug of a connector of the first embodiment;

FIG. 2 is a cross-sectional view showing the receptacle along line X-X shown in FIG. 1;

FIG. 3A is a perspective view showing a projecting terminal formed integrated with an external terminal;

FIG. 3B is a plan view showing a projecting terminal provided at a portion partly projecting in a width direction;

FIG. 4 is a perspective view showing a plug shown in FIG. 1 turned over;

FIG. 5A is an enlarged diagram showing a contact point of the plug;

FIG. 5B is a cross-sectional view along line Y-Y shown in FIG. 5A;

FIG. 6 is an enlarged cross-sectional view showing a structure of a metal layer of an elastic section of the contact point;

FIG. 7 is an enlarged diagram showing the contact point of the plug when a tip section of the contact point is curved;

FIG. 8 is a perspective view showing a connector where the plug is mounted to the receptacle and covered with a shield cover;

FIG. 9A is an explanatory cross-sectional view showing an operation of the connector of the present embodiment where the projecting terminal 5 is in contact with the contact point from the bottom side;

FIG. 9B is an explanatory cross-sectional view showing an operation of the connector of the present embodiment where the projecting terminal is inserted into the contact point;

FIG. 9C is an explanatory cross-sectional view showing an operation of the connector of the present embodiment where the insertion of the projecting terminal into the contact point is completed;

FIG. 10A is an explanatory cross-sectional view showing the elastic section of the contact point when composed of only the metal layer;

FIG. 10B is a cross-sectional view showing a gap formed between the projecting terminal and the metal layer of the contact point;

FIG. 11A is a plan view showing a modification of the elastic section of the contact point when a corner section of the elastic section is cut out in a tapered shape;

FIG. 11B is a plan view showing a modification of the elastic section of the contact point when the tip section of the elastic section is formed in a saw-toothed shape;

FIG. 11C is a plan view showing another modification of the elastic section of the contact point when the tip section of the elastic section is formed in a saw-toothed shape;

FIG. 12 is an exploded perspective view showing a structure such as a receptacle and plug of a connector (optical transmission module) of the second embodiment;

FIG. 13 is a perspective view showing a circuit structure of a circuit substrate of the plug of the second embodiment;

FIG. 14 is an explanatory side view showing a structure of a hinge section;

FIG. 15 is an exploded perspective view showing a structure such as a receptacle and plug of a connector (optical-electrical transmission module) of the third embodiment;

FIG. 16 is a perspective view showing a circuit structure of a circuit substrate of the plug of the third embodiment;

FIG. 17 is a perspective view showing an example of a structure of a piece for releasing fitting;

FIG. 18 is a diagram showing a conventional optical transmission module and optical transmission waveguide film;

FIG. 19A is an exploded perspective view of the optical transmission module shown in FIG. 18; and

FIG. 19B is an explanatory cross-sectional view showing a connection of a connector main body and a lower case shown in FIG. 19A.

### DESCRIPTION OF THE PREFERRED EMBODIMENTS

The best mode for carrying out a connector and an optical transmission module and optical-electrical transmission module using the connector according to the present invention will be explained in detail with reference to the drawings. However, the scope of the invention is not limited by the illustrated examples.

### First Embodiment

A plug constituting a connector formed on one end of the film cable is described in the first embodiment.

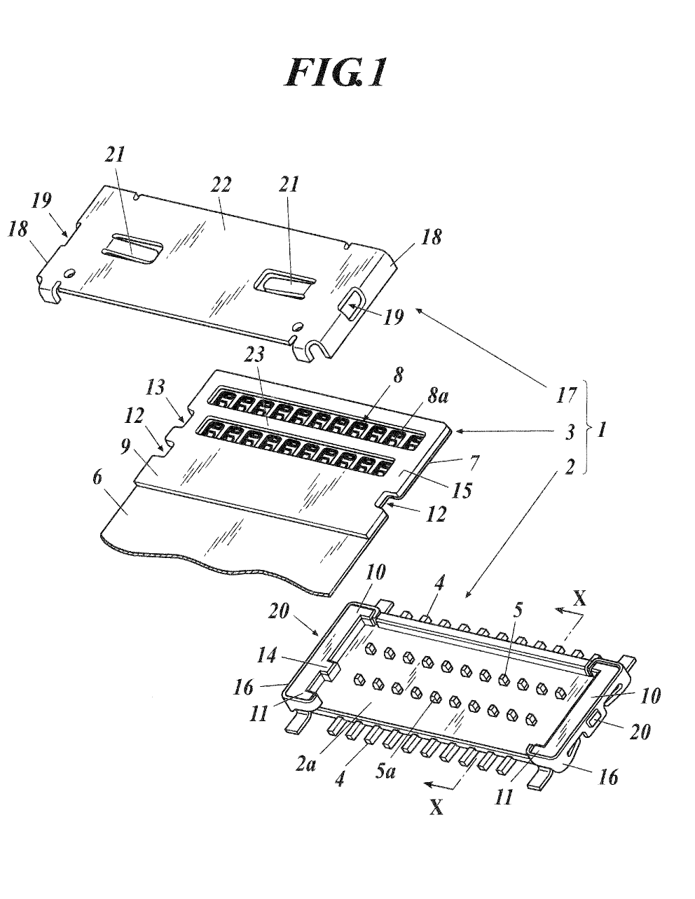

As shown in FIG. 1, the connector 1 of the present embodiment includes a receptacle 2 provided on a substrate (not shown) and a plug 3 connected to the receptacle 2.

The specification describes the embodiment using the terms up, down, horizontal direction, etc. based on when the base section 2a of the receptacle 2 extends in a horizontal direction and point 5a of a projecting terminal 5 is placed to project upward as shown in FIG. 1. However, the terms up, down, horizontal direction, etc. are to describe a relative relation of position of each member. In other words, needless to say, for example, when the receptacle 2 is mounted downward and the point 5a of the projecting terminal 5 is placed projecting downward, the up and down described below is reversed, and when the receptacle 2 is mounted sideways and the point 5a of the projecting terminal 5 is placed projecting in the horizontal direction, the direction describing vertical direction means the horizontal direction.

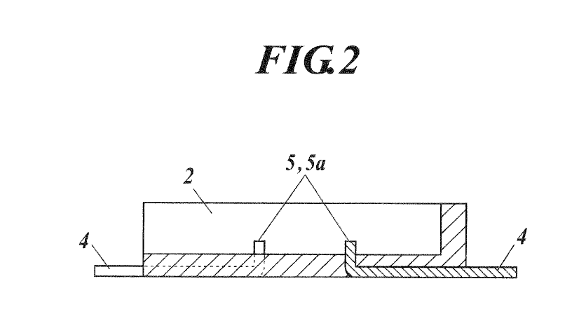

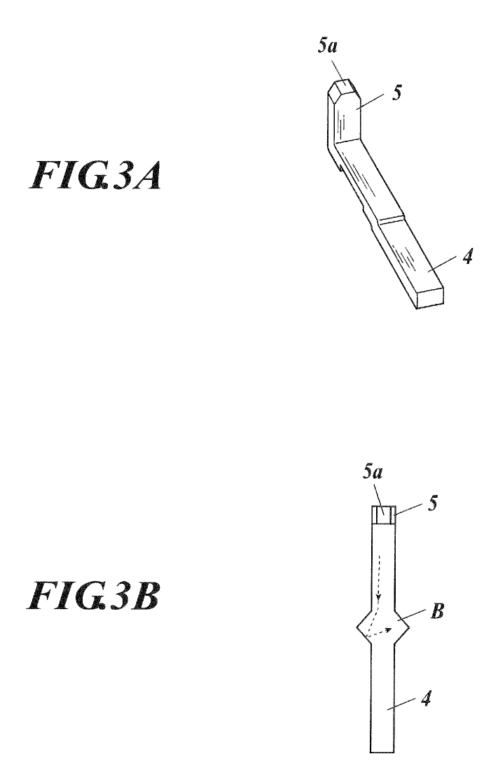

A projecting terminal 5 electrically connected to an external terminal 4 is provided in the receptacle 2. In the present embodiment, the projecting terminal 5 is formed integrally on the external terminal 4 so that as shown in the cross-sectional view shown in FIG. 2, one end of the external terminal 4 extending in a substantially horizontal direction is bent upward to form the projecting terminal 5, and the external terminal 4 and projecting terminal 5 form a substantial L-shape. As shown in FIG. 3a, the projecting terminal 5 is formed so that widths of the projecting terminal 5 and the portion of external terminal 4 are even by insert molding. Forming the projecting terminal 5 with this method enables manufacturing at a low cost.

For example, as shown in the flat view shown in FIG. 3B, when there is a projecting portion B in the projecting terminal 5 in the width direction, especially in a case where a high frequency electrical signal is transmitted to inside or surface of the projecting terminal 5, for example, the electrical signal transmitted from the projecting terminal 5 to the external terminal 4 is reflected by the projecting portion B as shown in the dotted arrow in the figure, and thus causes transmitting efficiency of the electrical signal to decrease.

However, as in the present embodiment, by forming the projecting terminal 5 so that the width is even, such reduction of the transmitting efficiency of the electrical signal can be prevented. Also, since an extra structure such as the projecting section B is not provided in the projecting terminal 5, the projecting terminal 5 can be formed slimmer, and a plurality of projecting terminals 5 can be placed with a narrower placement interval and the pitch can be made narrower.

In the present embodiment, as shown in FIG. 1, the plurality of projecting terminals 5 are fixed to the receptacle 2 so that each point 5a projects upward from the base section 2a of the receptacle 2 and projecting positions of each point 5a are placed in a zigzag alignment on the base section 2a of the receptacle 2.

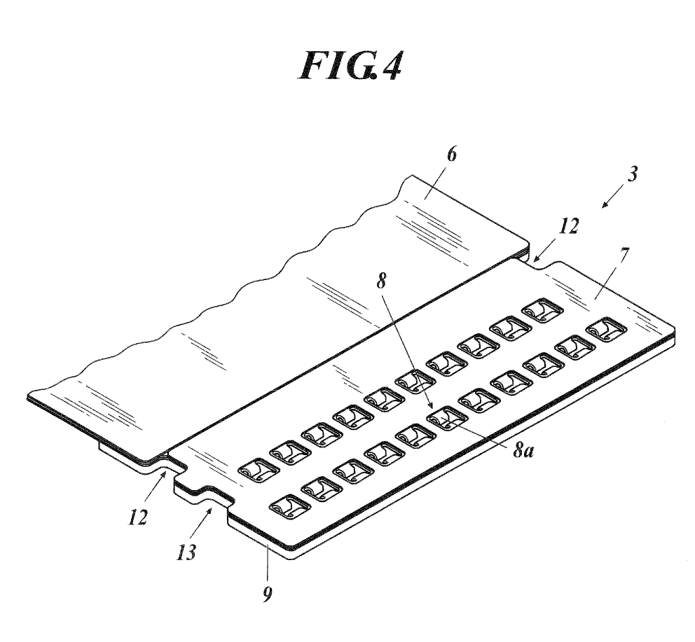

In the present embodiment, as shown in FIG. 4 showing the plug 3 shown in FIG. 1 turned over, the plug 3 includes, a film cable 6 and a circuit substrate 7 fixed to one end of the film cable 6 and electrically connected to the film cable 6. The circuit substrate 7 of the plug 3 is composed of, for example, a Flexible Printed Circuit (FPC).

Contact points 8 are provided on the circuit substrate 7 of the plug 3 at each position corresponding to each point 5a of the plurality of projecting terminals 5 provided on the receptacle 2. In the present embodiment, as described above, since each point 5a of the plurality of projecting terminals 5 are placed in a zigzag alignment on the base section 2a of the receptacle 2, each contact point 8 is also placed in a zigzag alignment on the circuit substrate 7. Each contact point 8 is each connected to each wiring (not shown) in the film cable 6.

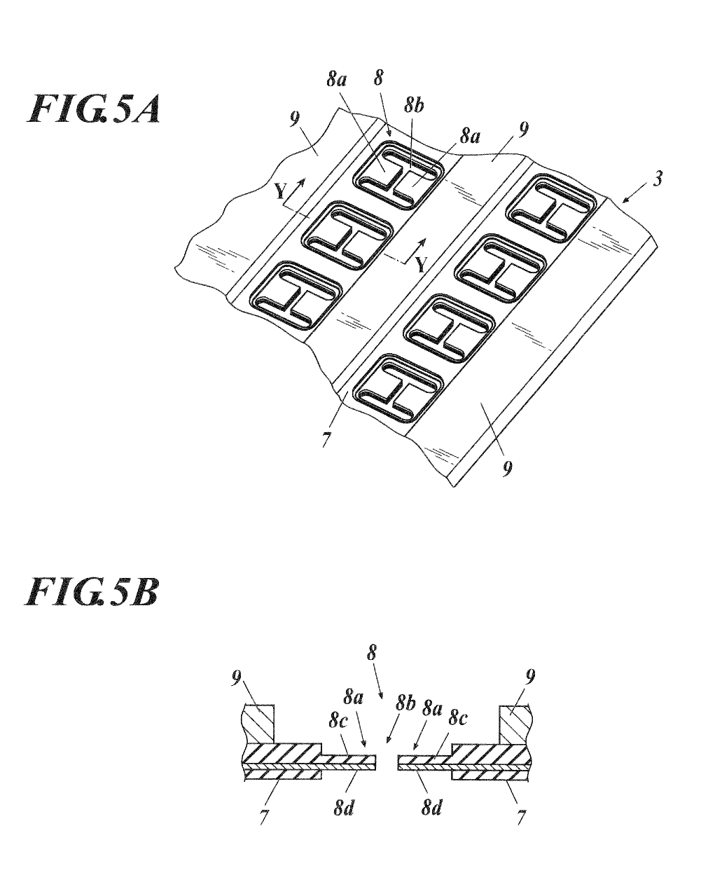

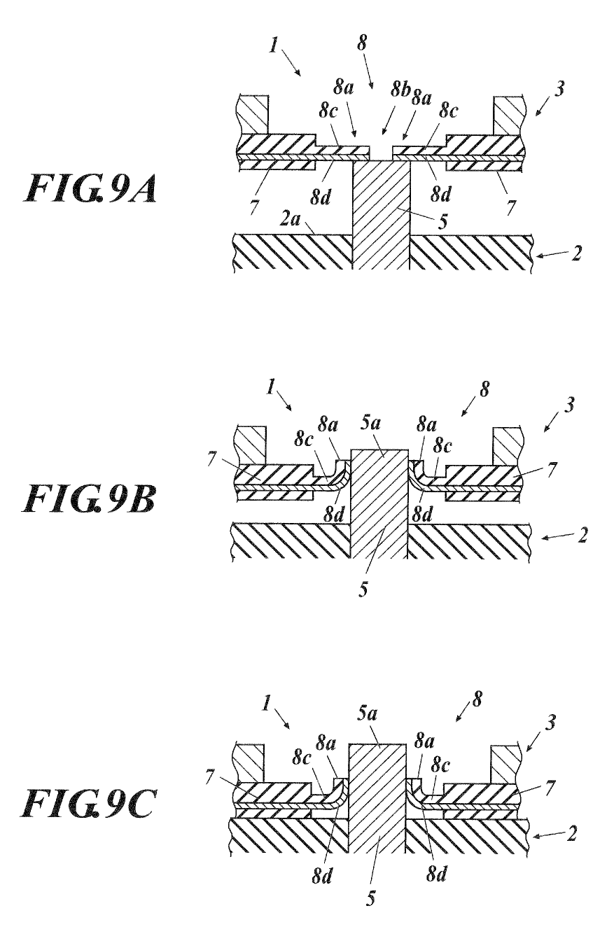

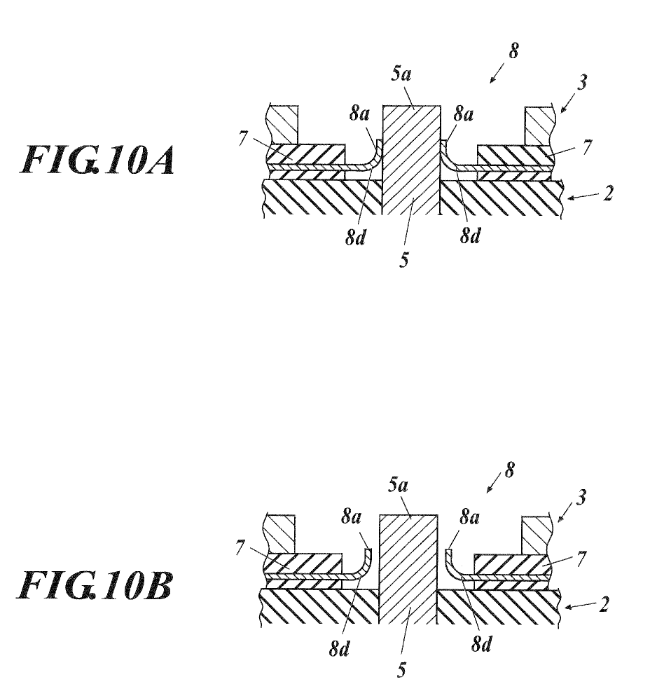

As shown in the enlarged diagram shown in FIG. 5A, as a basic structure, the contact point 8 includes a hole 8b parted in a substantial H-shape by an elastic section 8a formed in two tongue piece shapes tip sections of which are facing each other. Also, as described later in FIG. 9A to FIG. 9C, the elastic section 8a of the contact point 8 are provided extending in a direction orthogonal to the inserting direction of the point 5a of the projecting terminal 5 provided in the receptacle 2. Incidentally, in each figure from FIG. 5 and after, other than the cross-sectional diagram and side-view diagram, the figures show a diagram where the plug 3 is viewed from above as in FIG. 1.

In the present embodiment, as shown in the cross-sectional diagram shown in FIG. 5B, the contact point 8 is formed so that thickness of the elastic section 8a of the contact point 8 is thinner than thickness of other portions of the circuit substrate 7. This is because, as described below, the elastic section 8a needs to be able to elastically deform when the point 5a of the projecting terminal 5 provided on the receptacle 2 is inserted in the hole 8b of the contact point 8.

Moreover, when the other portions of the circuit substrate 7 of the plug 3 are formed thin, deformation such as torsion easily occurs in the circuit substrate 7 and the circuit substrate 7 partially rises from the receptacle 2 when the circuit substrate 7 is mounted to the receptacle 2. Therefore, the point 5a of the projecting terminal 5 cannot be accurately inserted in the hole 8b of the contact point 8 where it is rising, and a good electrical connection cannot be obtained.

However, by forming the circuit substrate 7 thick as in the present embodiment, deformation of the circuit substrate 7 can be prevented and the rising of the circuit substrate 7 from the receptacle 2 can be prevented.

In the present embodiment, in order to further reliably prevent the rising of the circuit substrate 7 from the receptacle 2 due to deformation of the circuit substrate 7, as shown in FIG. 1, FIG. 5A, FIG. 5B, etc., a torsion preventing member 9 provided with an opening at a position corresponding to the contact point 8 is mounted to the circuit substrate 7. The torsion preventing member 9 is formed by a member with rigidity such as a metal plate.

In the present embodiment, as described above, the circuit substrate 7 of the plug 3 is composed of a FPC. The FPC is usually formed by applying a copper foil to an insulating layer such as polyimide, and there are various forms of such layered structure. In the present embodiment, as shown in FIG. 5B, the elastic section 8a of each contact point 8 includes at least an insulating layer 8c with elasticity and a metal layer 8d for electrical connection provided on a face of the insulating layer 8c facing the projecting terminal 5, in other words, a bottom face of the insulating layer 8c. The metal layer 8d is connected to each wiring of the film cable 6.

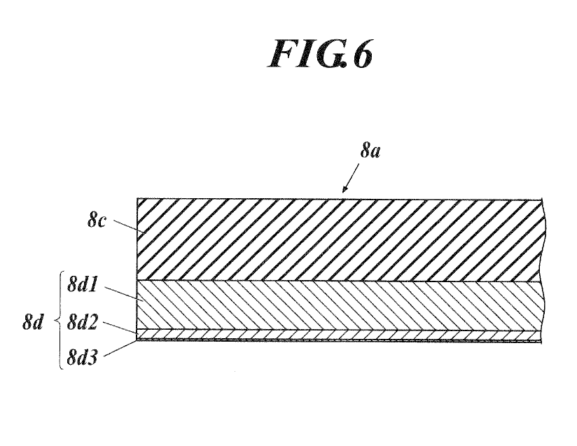

In the present embodiment, an insulating layer such as polyimide of the FPC composing the circuit substrate 7 is used in the insulating layer 8c of the elastic section 8a of the contact point 8. Also, as shown in the enlarged cross-sectional diagram of FIG. 6, the metal layer 8d is formed by laminating layers 8d2 and 8d3 of nickel (Ni), gold (Au) and the like respectively on a bottom face of a copper foil 8d1 composing the FPC by electrolytic plating. When nickel and gold are laminated on the copper foil by electroless plating, as described later, there is a possibility that a defect such as a crack occurs in the laminated portion of the nickel and gold when the elastic section 8a is deformed when the point 5a of the projecting terminal 5 is inserted in the elastic section 8a, however, by laminating with electrolytic plating, such defect can be prevented.

In the present embodiment, an example is described where nickel and gold is laminated on a bottom face of the copper foil composing the FPC however, the entire metal layer 8d of the elastic section 8a can be newly formed by a method such as plating the insulating layer 8c.

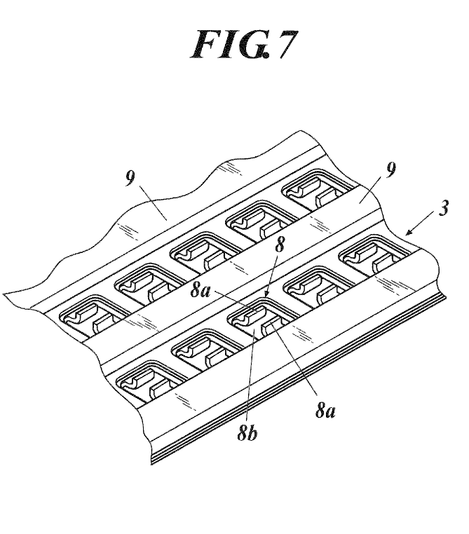

Also, as shown in FIG. 5A and FIG. 5B, an example is shown where the two elastic sections 8a of the contact point 8 are formed in a flat plate shape, however, as shown in FIG. 7, the tip section of each elastic section 8a can be formed curved in advance in the inserting direction of the projecting terminal 5, in other words, upward. Incidentally, FIG. 1 and FIG. 4 show the tip section of the elastic section 8a curved upward (FIG. 4 is shown in a status turned over, therefore, in the figure, the tip section of the elastic section 8a is shown curved downward).

As described above, by curving in advance each tip section of each elastic section 8a of the contact point 8 in the inserting direction of the projecting terminal 5, when the plug 3 is mounted to the receptacle 2, the point 5a of the projecting terminal 5 provided on the receptacle 2 fits in the curved portion of the elastic section 8a of the contact point 8 and enables easy alignment of the projecting terminal 5 to the contact point 8.

In the present embodiment, a wrong insertion prevention mechanism is provided to prevent wrong insertion such as mounting front and back of the plug 3 opposite when mounting the circuit substrate 7 of the plug 3 to the receptacle 2.

Specifically, as shown in FIG. 1, on the left and right edge of the circuit substrate 7 of the plug 3 and the torsion preventing member 9 mounted thereon, in the extending direction of the film cable 6, engaging concave sections 12 and 12 are provided to engage to the engaging convex sections 11 and 11 each provided facing inward on the short side wall section 10 and 10 of the receptacle 2 formed in a substantially rectangular shape from a plan view to align the plug 3 with the receptacle 2 and to prevent the plug 3 from escaping from the receptacle 2 in the extending direction of the film cable 6.

However, with only the above, for example, even when the front and back of the plug 3 is mounted opposite, the engaging convex sections 11 and 11 of the receptacle 2 side and the engaging concave sections 12 and 12 of the plug 3 side can be engaged, and thus there are cases where one who is mounting the plug 3 does not realize wrong insertion.

Therefore, in the present embodiment, a wrong insertion prevention mechanism is formed where on the plug 3 side, a concave section 13 separate from the engaging concave section 12 is provided either on the left or right edge of the circuit substrate 7 and the torsion preventing member 9 mounted thereon in the extending direction of the film cable 6, and on the receptacle 2 side, a convex section 14 is provided facing inward on the short side wall section 10 of the receptacle 2 on a side where a concave section 13 on the plug 3 side is positioned when the plug 3 is correctly mounted to the receptacle 2.

As described above, by providing a convex section 14 and a concave section 13 on either left or right side on the receptacle 2 side and the plug 3 side in the extending direction of the film cable 6, for example, when the front and back of the plug 3 is mounted opposite, the side of an end 15 where the concave section 13 of the plug 3 is not provided hits the convex section 14 of the receptacle 2 and prevents the insertion of the plug 3, the one who mounts the plug 3 realizes the wrong insertion and can insert the plug 3 into the receptacle 2 correctly.

A shield case 16 formed by metal material is provided on the receptacle 2 on the outside of at least the short side wall sections 10 and 10. The shield case 16 is for shielding the projecting terminal 5 provided on the receptacle 2, a contact point 8 of the plug 3 connected thereto, etc., from an external interfering wave, and by shielding the interfering wave, normal electrical signal transmission through the above is maintained. In order to obtain this object, the shield case 16 can be composed to cover the bottom face or side wall of the long side where the external terminal 4 of the receptacle 2 is provided.

Also, for the same purpose, a shield cover 17 formed by metal material is mounted on the receptacle 2.

As shown in FIG. 1, on the shield cover 17, at least the left and right edges in an extending direction of the film cable 6 are hung down to form side wall sections 18 and each side wall section 18 is provided with a latching hole 19. Each shield case 16 on the receptacle 2 side is provided with a latching projection section 20 formed to project outward respectively.

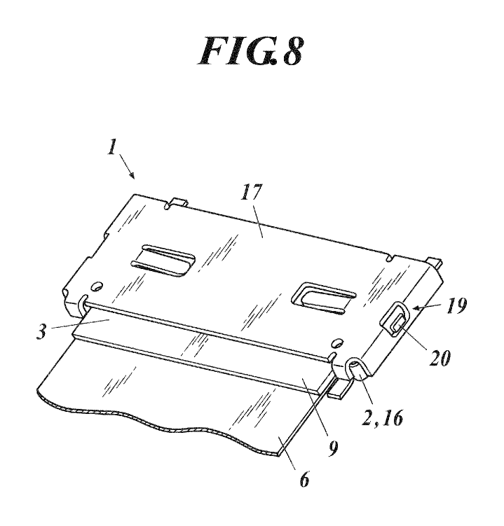

As shown in FIG. 8, when the receptacle 2 mounted with the plug 3 is covered with the shield cover 17, the latching projection section 20 of the shield case 16 on the receptacle 2 side latches to the latching hole 19 of the shield cover 17 to lock the shield cover 17 to the shield case 16 and a lock mechanism is formed by the latching hole 19 and the latching projection section 20.

As described above, since the shield cover 17 is locked to the shield case 16 to be reliably latched to the receptacle 2, the projecting terminal 5 provided on the receptacle 2, contact point 8 of the plug 3, etc. (see FIG. 1, etc.) are shielded from external interfering waves and normal transmission of electrical signal through the above is maintained. Also, since the projecting terminal 5 is inserted in each contact point 8 of the plug 3 and the engaging convex section 11 of the circuit substrate 7 of the plug 3 and of the torsion preventing member 9 is engaged to the engaging concave section 12 of the receptacle 2, the plug 3 escaping from the receptacle 2 in the extending direction of the film cable 6 can be reliably prevented.

Also, as shown in FIG. 1, elastic holding sections 21 and 21 are provided on the shield cover 17 to elastically press the plug 3 from above when the shield cover 17 is mounted to the receptacle 2 so that each projecting terminal 5 provided on the receptacle 2 is reliably inserted in each contact point 8 of the plug 3 to make a further reliable electrical connection between the projecting terminal 5 and the contact point 8.

In the present embodiment, the elastic holding sections 21 and 21 are formed with two pieces stamped out in a U-shape at a position of a top face 22 of the shield cover 17 symmetrical with respect to an extending direction of the film cable 6 and the two pieces slightly bend downward. Also, each elastic holding section 21 and 21 contact and press a beam-like portion 23 of the torsion preventing member 9 provided between each column of each contact point 8 formed in two columns in a zigzag alignment on the circuit substrate 7 and the elastic holding sections 21 and 21 press each contact point 8 of the two columns front and back in the extending direction of the film cable 6 on the circuit substrate 7 through the torsion preventing member 9.

As described above, it is preferable that the elastic holding sections 21 press each contact point 8 of the plug 3 at a position symmetrical with respect to the extending direction of the film cable 6 or with respect to a line perpendicular to the extending direction of the film cable 6. With this structure, contact points 8 of the plug 3 are pressed evenly by the elastic holding section 21 and each of the projecting terminals 5 are reliably inserted in all of the contact points 8 and thus electrically connected reliably.

Also, even when vibration or impact is applied to the connector 1 in use inside a mobile terminal etc., since the plug 3 is pressed to the receptacle 2 side by the elastic holding sections 21, the plug 3 rattling inside the receptacle 2, shield cover 17, etc., can be prevented. The elastic holding section 21 is to function as described above, and the number of elastic holding sections 21 formed is not limited to two.

Next, the operation of the connector 1 of the present embodiment is described.

When the plug 3 is mounted to the receptacle 2, as shown in FIG. 9A, first, the point 5a of the projecting terminal 5 provided on the receptacle 2 projecting upward from the base section 2a of the receptacle 2 contacts each contact point 8 of the circuit substrate 7 of the plug 3 from the bottom. In other words, the point 5a of the projecting terminal 5 contacts the metal layer 8d of the elastic section 8a of the contact point 8 from the bottom.

Then, when the plug 3 is pushed further down, as shown in FIG. 9B, the point 5a of the projecting terminal 5 is inserted in the hole 8b of the contact point 8 and the insulating layer 8c and the metal layer 8d of the elastic section 8a bend in an inserting direction of the projecting terminal 5, in other words, each moving upward. Then, the projecting terminal 5 enters between the two elastic sections 8a while bending each elastic section 8a.

As described above, since the insulating layer 8c of the elastic section 8a of the contact point 8 is composed of material having elasticity such as polyimide, the insulating layer 8c elastically bends. In other words, if the projecting terminal 5 is pulled out, due to elasticity, the insulating layer 8c attempts to return to its original flat state, or when the tip section is formed curved upward in advance as shown in FIG. 7 etc., the insulating layer 8c attempts to return to this state. Therefore, as shown in FIG. 9B, the bent insulating layer 8c applies force so as to press the side face of the projecting terminal 5 from the side with its resilience.

Therefore, the metal layer 8d of the elastic section 8a is brought into contact by pressure with the side face of the projecting terminal 5 and while the projecting terminal 5 is pushed into the contact point 8 of the plug 3 and moves upward relative with respect to the elastic section 8a, the side face of the projecting terminal 5 is substantially rubbed by the metal layer 8d of the elastic section 8a.

Then, as shown in FIG. 9C, when the projecting terminal 5 is pushed into the contact point 8 of the plug 3, the side face of the projecting terminal 5 is rubbed by the metal layer 8d of the elastic section 8a of the contact point 8 and the attached matter, etc. on the side face of the projecting terminal 5 is rubbed off and removed. Therefore, there are no inclusions at least between the projecting terminal 5 and the metal layer 8d of the elastic section 8a of the contact point 8 and the projecting terminal 5 and the contact point 8 are reliably in contact through the metal layer 8d. Below, the effect of removing attached matter, etc. on the surface of the projecting terminal 5 by rubbing the projecting terminal 5 with the metal layer 8d using the resilience of the insulating layer 8c of the elastic layer 8a is called the cleaning effect.

Also, as shown in FIG. 9C, since the resilience of the insulating layer 8c is maintained after the projecting terminal 5 is completely inserted in the contact point 8 of the plug 3, the metal layer 8d continues to be brought into contact by pressure with the side face of the projecting terminal 5, and the contact between the projecting terminal 5 and the contact point 8 through the metal layer 8d as described above is maintained.

As described above, by only inserting the point 5a of the projecting terminal 5 provided on the receptacle 2 into the contact point 8, the resilience due to the elastic deformation of the elastic section 8a of the contact point 8 enables the cleaning effect as described above and the projecting terminal 5 and the contact point 8 are reliably electrically connected. Also, by the above described resilience, the metal layer 8d of the contact point 8 is brought into contact by pressure with the projecting terminal 5, and the above described electrical connection is reliably maintained.

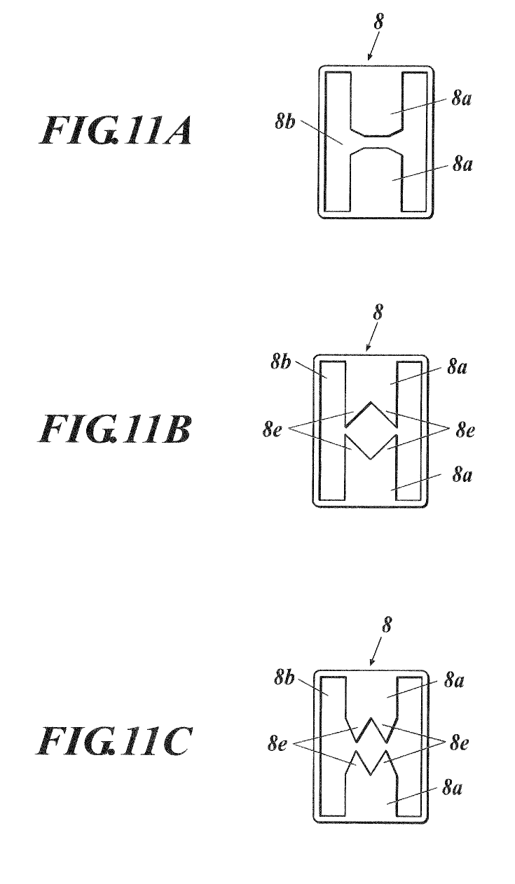

As shown in FIG. 10A, the effect of contact by pressure with the projecting terminal 5 by the metal layer 8d of the elastic section 8a or the cleaning effect described above when the projecting terminal 5 is inserted into the contact point 8 can be obtained even when the elastic section 8a is composed with only the metal layer 8d without providing the insulating layer 8c in the elastic section 8a of the contact point 8. In the present embodiment, the thickness of the metal layer 8d of the elastic section 8a is only 10 μm to several tens of μm, therefore, when the elastic section 8a is formed with only the metal layer 8d, the metal layer 8d needs to be formed with some degree of thickness.

However, when the elastic section 8a is composed of only the metal layer 8d, when the projecting terminal 5 is completely inserted into the contact point 8, the metal layer 8d retains the shape bent upward as shown in FIG. 10A and the resilience of the metal layer 8d becomes weak or does not act.

Then, when the entire connector vibrates and the projecting terminal 5 moves relatively in the left and right direction shown in FIG. 10A in the contact point 8 of the plug 3, since the resilience of the metal layer 8d is weak or does not act, a gap is formed between the projecting terminal 5 and the metal layer 8d of the contact point 8 as shown in FIG. 10B, and there is a case where the electrical connection between the contact point 8 of the plug 3 and the projecting terminal 5 is lost over time.

Also, in order to avoid the above, if the thickness of the metal layer 8d is made even thinner when the elastic section 8a is composed of only the metal layer 8d, then there is a case where the above described effect of contact by pressure with the projecting terminal 5 by the metal layer 8d of the elastic section 8a or the cleaning effect cannot be adequately obtained when the projecting terminal 5 is inserted in the contact point 8 and the electrical connection between the contact point 8 of the plug 3 and the projecting terminal 5 cannot be adequately obtained.

As described above, according to the connector 1 of the present embodiment, when the projecting terminal 5 provided on the receptacle 2 is inserted in the contact point 8 of the plug 3, the metal layer 8d of the elastic section 8a is brought into contact by pressure with the projecting terminal 5 by the resilience due to the elastic deformation of the elastic section 8a of the contact point 8 to automatically and reliably connect the contact point 8 and the projecting terminal 5 electrically.

As described above, according to the connector 1 of the present embodiment, by only inserting the projecting terminal 5 into the contact point 8 of the plug 3, the electrical connection can be reliably obtained, and a mechanism to secure the electrical connection does not need to be newly provided. Therefore, each contact point 8 of the plug 3 and each projecting terminal 5 can be formed in a compact form in an order of several tens of μm to several hundreds of μm where adequate and reliable electrical connection can be obtained and maintained and thereby the entire connector 1 can be made smaller.

The projecting terminal 5 is projected from the receptacle 2 to a degree where electrical connection with the contact point 8 of the plug 3 is secured, and in this case, the electrical connection can be secured and maintained adequately when projected in an order of several tens of μm to several hundreds of μm. Therefore, the thickness of the receptacle 2 and the plug 3 in the vertical direction can be formed adequately thin, and the entire connector 1 including the shield cover 17 can be made shorter in height to a thickness of about 1 mm.

Incidentally, as described above, in the present embodiment, the electrical connection between the metal layer 8d of the elastic section 8a and the projection terminal 5 is obtained and maintained by the resilience of the insulating layer 8c of the elastic section 8a of the contact point 8 of the plug 3. When the thickness of the insulating layer 8c is too thin, the resilience becomes weak and on the other hand, when the thickness of the insulating layer 8c is too thick, the resilience becomes too strong to be difficult to insert the projecting terminal 5 into the contact point 8. Therefore, depending on the type of resin, etc., used in the insulating layer 8c, the thickness of the insulating layer 8c of the elastic section 8a of the contact point 8 is suitably determined so that a suitable resilience can be obtained.

Also, the present embodiment describes an example where elastic sections 8a in two tongue-shaped pieces composing one contact point 8 are provided each extending in a square shape as shown in FIG. 5A, etc., however, for example, as shown in FIG. 11A, a corner section of the square-shaped elastic section 8a can be cut out in a tapered shape.

Further, the present embodiment describes an example where tip sections of two tongue-shaped elastic sections 8a composing one contact point 8 are formed substantially parallel to each other as shown in FIG. 5A, etc., however, as shown in FIG. 11B and FIG. 11C, a plurality of portions of the tip section of the elastic section 8a can be formed in a saw-toothed shape including a plurality of projecting sections 8e projecting to the coupling elastic section 8a.

As described above, when the tip section of the elastic section 8a is cut out in a tapered shape or the tip section of the elastic section 8a is in a saw-toothed shape formed with a plurality of projecting sections 8e, the insulating layer 8c and the metal layer 8d of the elastic section 8a are formed in a same shape. When the layers are formed in such a shape, the contact area between the metal layer 8d and the side face of the projecting terminal 5 is small when the metal layer 8d pressurizes to be in contact with the side area of the projecting terminal 5 (see FIG. 9C, etc.), and therefore, the pressure when pressurized becomes high.

Therefore, the metal layer 8d of the elastic section 8a can be pressurized strongly by the projecting terminal 5 to be in contact with each other and the reliability of the electrical connection between the contact point 8 of the plug 3 and the projecting terminal 5 can be enhanced.

### Second Embodiment

The second embodiment describes an example where a plug composing a connector is formed on one end of an optical transmission waveguide film and the plug mutually converts an electrical signal and optical signal to send and receive the signals. As described above, in the present embodiment, an optical transmission module is formed by the connector. Therefore, below, the connector 30 can be read as the optical transmission module 30.

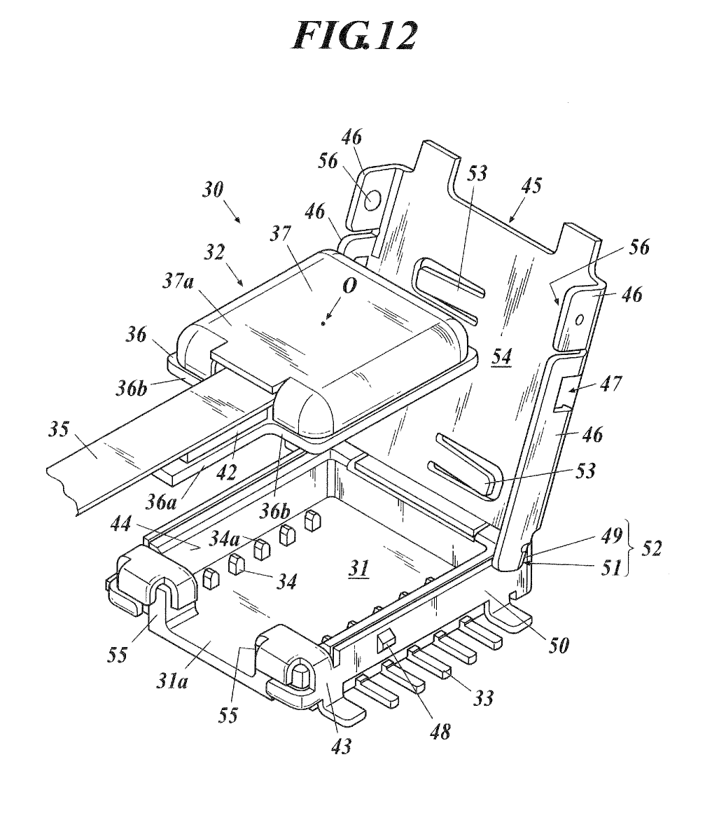

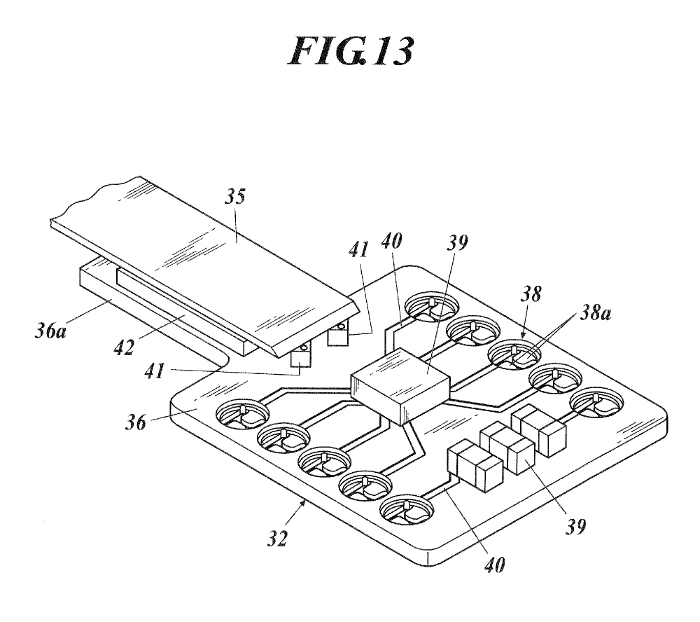

As shown in FIG. 12, the connector 30 of the present invention includes a receptacle 31 provided on a substrate (not shown) and a plug 32 connected to the receptacle 31.

On the receptacle 31, a projecting terminal 34 is provided electrically connected to the external terminal 33. In the present embodiment also, similar to the projecting terminal 5 shown in FIG. 2 and FIG. 3A of the first embodiment, the projecting terminal 34 is formed integrated with the external terminal 33 in a substantial L-shape, and is formed by insert molding so that the width is even. Therefore, the transmission efficiency of the electrical signal transmitted inside and on the surface of the projecting terminal 34 becoming lower can be prevented and the projecting terminal 34 can be slimmer and the pitch can be narrower.

Also, the projecting terminal 34 is fixed to the receptacle 31 so that the point 34a projects upward from the base section 31a of the receptacle 31. Also, in the present embodiment, the projecting position of each point 34a of a plurality of projecting terminals 34 is placed near an inner peripheral edge of the base section 31a of the receptacle 31.

In the present embodiment, the plug 32 includes an optical transmission waveguide film 35, circuit substrate 36, etc. A protective cover 37 including metal material to function as a shield cover to shield from an external interfering wave is provided on the circuit substrate 36 so as to cover each electronic component, etc. of the later described circuit substrate 36.

In the present embodiment, the protective cover 37 is connected to a ground wiring of the circuit substrate 36 and also functions as a ground of the circuit substrate 36. The protective cover 37 also has a function as a wrong insertion prevention mechanism to prevent wrong insertion of the plug 32 to the receptacle 31. As described later, the protective cover 37 also has a function of allowing the projecting terminal 34 provided on the receptacle 31 to be inserted reliably to each contact point 38 of the circuit substrate 36 by pressing the circuit substrate 36 toward the receptacle 31 side to prevent the rising of the circuit substrate 36 by being pressed from the above with elastic holding sections 53 and 53 provided in the shield cover 45.

FIG. 13 is a perspective view showing a circuit structure of a circuit substrate of a plug. FIG. 13 shows the plug 32 without the protective cover 37.

The circuit substrate 36 of the plug 32 is composed of for example, an FPC. Contact points 38 are provided on the circuit substrate 36 of the plug 32 in each position corresponding to each point 34a of the plurality of projecting terminals 34 provided on the receptacle 31. In the present embodiment, the structure, modification, function, etc. of the contact point 38 is the same as the structure (see FIG. 5A, FIG. 5B, etc.), modification (see FIG. 7, FIG. 11A, FIG. 11B, FIG. 11C, etc.), and function (FIG. 9A to FIG. 9C, etc.) of the contact point 8 of the first embodiment described above, therefore the explanation is omitted.

As in the above described first embodiment, a torsion preventing member can be mounted on the contact point 38 of the plug 32 in the present embodiment also to prevent deformation such as torsion, etc. of the circuit substrate 36. However, in the present embodiment, the thickness of the circuit substrate 36 itself is formed thick to prevent deformation such as torsion, etc. of the circuit substrate 36 or the rising of the circuit substrate 36 from the receptacle 31.

Therefore, the thickness of an elastic section 38a of the contact point 38 is formed much thinner than the thickness of the other portion of the circuit substrate 36. However, as described in the first embodiment, the thickness of the elastic section 38a of the contact point 38 is suitably determined to obtain suitable resilience.

In the present embodiment, in addition to each contact point 38, the circuit substrate 36 of the plug 32 includes an electronic component 39 with a function such as converting the optical signal transmitted through the optical transmission waveguide film 35 to the electronic signal and converting the electronic signal transmitted through the projecting terminal 34 and the contact point 38 to the optical signal, wiring 40 to electronically connect each electronic component 39 and contact point 38, and optical signal sending and receiving section 41 to mutually convert the optical signal and electronic signal, to convert the optical signal transmitted through the optical transmission waveguide film 35 to the electronic signal, and to convert the electronic signal output from the electronic component 39 to the optical signal to output to the optical transmission waveguide film 35.

Also, an extending section 36a extending toward the optical transmission waveguide film 35 side is provided on the circuit substrate 36. Also, a spacer 42 is provided between the optical transmission waveguide film 35, where one end is mounted to the top end of the optical signal sending and receiving section 41, and the extending section 36a of the circuit substrate 36, and the optical transmission waveguide film 35 is fixed to the extending section 36a of the circuit substrate 36 through the spacer 42.

Thus, in the present embodiment, by providing the extending section 36a on the circuit substrate 36 and fixing the optical transmission waveguide film 35 to the extending section 36a through the spacer 42, the optical transmission waveguide film 35 can be prevented from moving relative to the circuit substrate 36 when external force is applied to the optical transmission waveguide film 35 at least near the circuit substrate 36 to accurately prevent the end of the optical transmission waveguide film 35 from disconnecting from the optical signal sending and receiving section 41 and not being able to perform sending and receiving of the optical signal.

As shown in FIG. 12, in the present embodiment, a shield case 43 including metal material is provided covering the outer wall face of the side wall 44 of the receptacle 31 to shield the receptacle 31 from the external interfering wave. The receptacle 31 is mounted with a shield cover 45 including metal material to shield the receptacle 31 from the external interfering wave.

At least the left and right edges of the shield cover 45 in the extending direction of the optical transmission waveguide film 35 hang down to form side wall sections 46, and each side wall section 46 is provided with a latching hole 47. Also, latching projections 48 formed projecting outward are provided on each shield case 43 of the receptacle 31 and when the shield cover 45 covers the receptacle 31 mounted with the plug 32, the latching projection 48 of the shield case 43 of the receptacle 31 latches with the latching hole 47 of the shield cover 45 to form a lock mechanism to lock the shield cover 45 to the shield case 43.

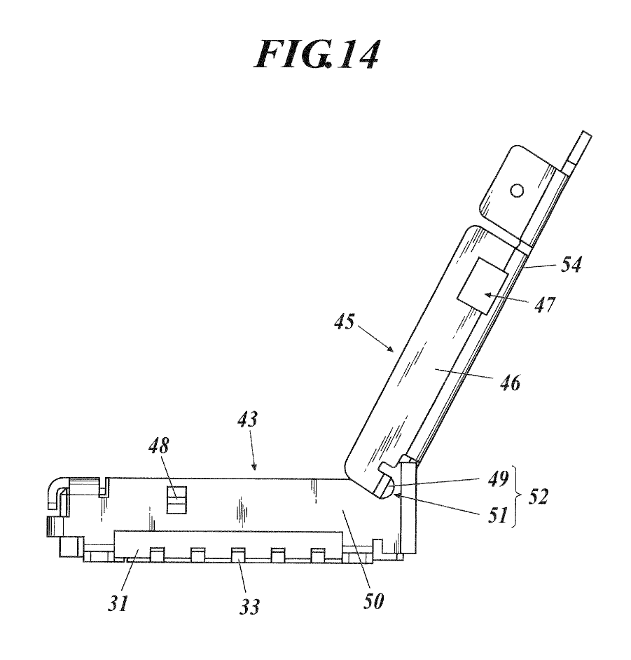

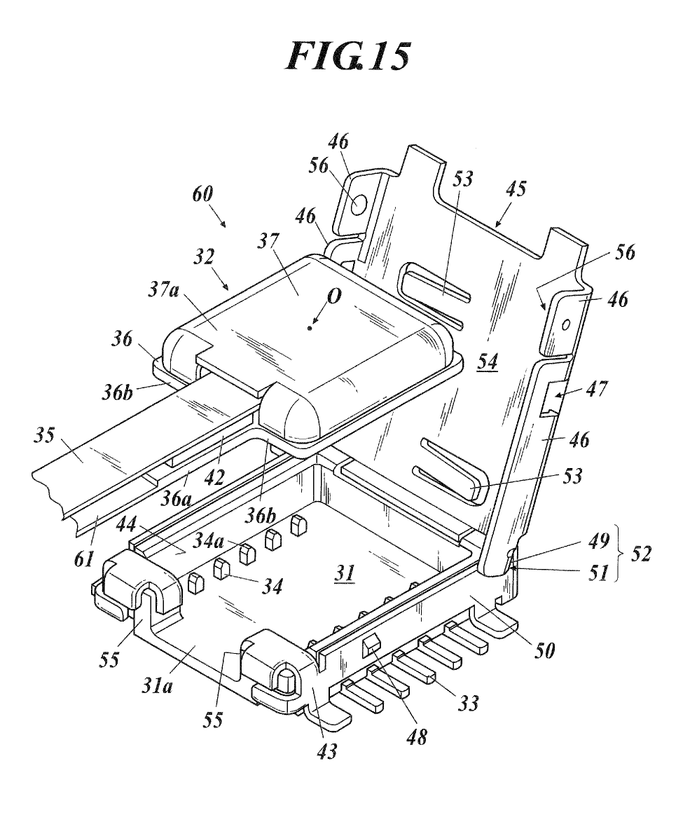

In the present embodiment, as shown in the side view shown in FIG. 14, the shield cover 45 is provided with a latching section 49 formed by folding the end of each side wall section 46 on the shield case 43 side inward in an unguiform and the shield case 43 has a hole 51 drilled in each side wall section 50 corresponding to each side wall section 46 of the shield cover 45.

Then, each of the unguiformed latching section 49 of the shield cover 45 is latched to each hole 51 of each of the side wall section 50 of the shield case 43 to compose a hinge section 52. The shield cover 45 is openable and closable with respect to the shield case 43 by the hinge section 52.

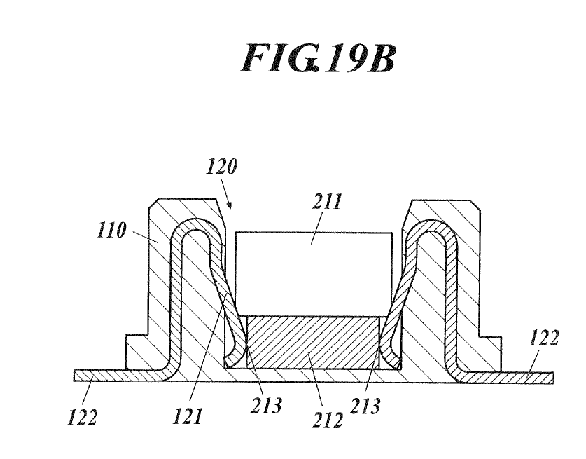

As described above, by forming a hinge section 52 by latching the unguiformed latching section 49 of the shield cover 45 to the hole 51 of the shield case 43, the number of components can be made smaller compared to for example, as shown in FIG. 19A, where a different pin 300 is provided to connect the shield case 301 of the connector main body 110 and the shield cover 302 so as to be openable and closable.

Also, even if the shield case 43 and the shield cover 45 is made smaller and shorter in height, for example, by attaching the shield case 43 and the shield cover 45 with a mounting device, the shield cover 45 can be easily and reliably mounted to the shield case 43 with the hinge section 52 so as to be openable and closable and the connector 30 (optical transmission module 30) can be made smaller and shorter in height.

Incidentally, in the first embodiment also, the shield cover 17 can be mounted through the hinge section to the shield case 16 so as to be openable and closable.

As shown in FIG. 12, in the present embodiment, elastic holding sections 53 and 53 are provided on the shield cover 45 to elastically press the protective cover 37 of the plug 32 from above to reliably insert each projecting terminal 34 provided on the receptacle 31 into each contact point 38 of the circuit substrate 36 of the plug 32 to reliably electrically connect the projecting terminal 34 and the contact point 38 when the shield case 43 is closed with the shield cover 45 and the plug 32 is mounted to the receptacle 31.

The elastic holding sections 53 and 53 include two pieces formed by stamping out a top face 54 of the shield cover 45 in a U-shape, which two pieces slightly bend downward. Also, in the present embodiment, the elastic holding sections 53 and 53 press positions on a top face 37a of the protective cover 37 symmetrical with respect to a center point O in a left and right direction and front and back direction of the extending direction of the optical transmission waveguide film 35 on the top face 37a of the protective cover 37 of the plug 32 when the shield cover 45 is closed.

As described above, since the elastic holding sections 53 and 53 press positions of the top face 37a of the protective cover 37 symmetrical with respect to the center point O, each contact point 38 of the plug 32 are pressed evenly by the elastic holding sections 53 and 53 and each projecting terminal 34 is reliably inserted in all of the contact points 38 and are thus reliably electrically connected.

Also, when the shield cover 45 is closed and locked to the shield case 43 and the plug 32 is pressed from above by the elastic holding sections 53 and 53 to insert each projecting terminal 34 to each contact point 38, the end face 36b of the circuit substrate 36 on the plug 3 frontward side in the extending direction of the optical transmission waveguide film 35 and the end face 55 on the receptacle 31 frontward side in the extending direction of the optical transmission waveguide film 35 are engaged. Therefore, combination of the above configurations reliably prevents the plug 32 from escaping from the receptacle 31 in the extending direction of the optical transmission waveguide film 35.

Further, in the present embodiment, as described above, the protective cover 37 of the plug 32 also functions as a ground of the circuit substrate 36. When the elastic holding sections 53 and 53 contact the protective cover 37, the protective cover 37 of the plug 32 is electrically connected to the shield cover 45 and, through the hinge section 52, the shield case 43. Therefore, the shield cover 45 and the shield case 43 also function as a ground of the circuit substrate 36 of the plug 32 and the grounding efficiency of the circuit substrate 36 of the plug 32 is further enhanced.

In the further embodiment, in order to make the electrical connection between the shield cover 45 and the shield case 43 more reliable, grounding projection sections 56 are provided by projecting a portion of an inner wall of each side wall section 46 of the shield cover 45 inward. When the shield case 43 is closed with the shield cover 45, each grounding projection section 56 contacts each side wall section 50 of the shield case 43 to enhance electrical connecting efficiency between the shield cover 45 and the shield case 43 and with this, the grounding efficiency of the circuit substrate 36 of the plug 32 is further enhanced.

The operation and effect of the above structure of the contact point 38 of the plug 32 of the connector 30 (optical transmission module 30) of the present embodiment and the operation and effect of composing the contact point 38 like the modification of the first embodiment (see FIG. 7, FIG. 11A, FIG. 11B, FIG. 11C etc.) are the same as the first embodiment.

Therefore, in the connector 30 (optical transmission module 30) of the present embodiment, when the projecting terminal 34 provided on the receptacle 31 is inserted in the contact point 38 of the plug 32, the metal layer (not shown) of the elastic section 38a is brought into contact by pressure with the projecting terminal 34 with the resilience due to the elastic deformation of the elastic section 38a of the contact point 38 and the contact point 38 and the projecting terminal 34 are automatically and reliably electrically connected.

By only inserting the projecting terminal 34 into the connecting point 38 of the plug 32, the electrical connection can be reliably obtained, and a mechanism to secure the electrical connection does not need to be newly provided. Therefore, each contact point 38 of the plug 32 and each projecting terminal 34 can be formed in a compact form in an order of several tens of μm to several hundreds of μm where adequate and reliable electrical connection can be obtained and maintained and the entire connector 30 (optical transmission module 30) can be made smaller.

The projecting terminal 34 is projected from the receptacle 31 to a degree where electrical connection with the contact point 38 of the plug 32 is secured, and in this case, the electrical connection can be secured and maintained adequately when projected in an order of several tens of μm to several hundreds of μm. Therefore, the thickness of the receptacle 31 and the plug 32 in the vertical direction can be formed adequately thin.

As described above, in the connector 30 (optical transmission module 30) of the present embodiment, depending on the number of projecting terminals 34 (external terminals 33) provided on the receptacle 31, the length in the left and right direction and the front and back direction of the extending direction of the optical transmission waveguide film 35 of the entire connector 30 (optical transmission module 30) can each be formed in an order of a few mm, and the connector 30 (optical transmission module 30) can be made smaller. Also, the thickness can be made shorter in height to about 1 mm including the shield cover 45.

### Third Embodiment

The third embodiment describes an example where a plug composing a connector is formed on one end of the optical transmission waveguide film, the plug mutually converts the electrical signal and the optical signal to send and receive the signals, and the plug includes the FPC for electrical signal transmission. As described above, according to the present embodiment, not only the optical signal but also the electrical signal can be transmitted by the connector and an optical-electrical transmission module is formed. Therefore, below, the connector 60 can be read as the optical-electrical transmission module 60.

The connector 60 (optical-electrical transmission module 60) of the present embodiment and the connector 30 (optical transmission module 30) of the second embodiment have almost the same structure and the operation and effect are also the same, therefore, only points different from the connector 30 (optical transmission module 30) of the second embodiment will be described below. Also, members composing the connector 60 (optical-electrical transmission module 60) of the present embodiment which are members with the same function as those of the connector 30 (optical transmission module 30) of the second embodiment will be described by applying the same reference numerals as those used in the second embodiment.

As shown in FIG. 15, the connector 60 of the present embodiment includes a receptacle 31 provided on a substrate (not shown) and a plug 32 connected to the receptacle 31. The present embodiment is different from the second embodiment in that an extending section 36a of a circuit substrate 36 which supports through a spacer 42 an optical transmission waveguide film 35 connected to the plug 32 is further extended parallel to an optical transmission waveguide film 35 to form a FPC 61 for electrical signal transmission.

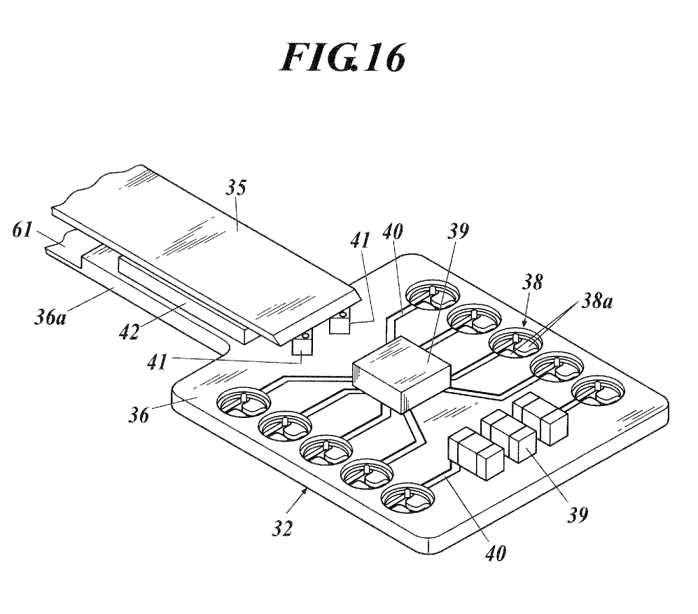

As shown in FIG. 16, an inner structure of the plug 32 is similar to the first embodiment (see FIG. 13) and the circuit substrate 36 of the plug 32 is provided with each contact point 38, electronic component 39, wiring 40 to electrically connect each electronic component 39 and contact point 38, and optical signal sending and receiving section 41.

Also, a plurality of wiring (not shown) is provided on the FPC 61 for electrical signal transmission and is directly connected to a wiring (not shown) of the circuit substrate 36 of the plug 32 or is connected through the electronic component 39. Then, the electronic signal sent and received in the FPC 61 for electrical signal transmission can be transmitted directly or through the electronic component 39 to the contact point 38 and then sent and received to a projecting terminal 34.

Further, as described above, the FPC composing the circuit substrate 36 of the plug 32 is formed thick to prevent deformation such as torsion of the circuit substrate 36 itself, however, the FPC 61 for electrical signal transmission needs to flexibly deform similar to the optical transmission waveguide film 35, therefore, the FPC 61 for electrical signal transmission is formed thinner than the circuit substrate 36.

As described above, in the connector 60 (optical-electrical transmission module 60) of the present embodiment, similar to the above described connector 30 (optical transmission module 30) of the second embodiment, the entire connector can be made smaller and shorter in height. Also, not only the optical signal but also the electrical signal can be sent and received together and the type of signal sent and received by the connector (module) can be many types and hybrized.

As for the above described plugs 32 of the connectors 30 and 60 of the second and third embodiments, after using the plug 32 with the shield cover 45 closed to reliably connect the plug 32 to the receptacle 31, the plug 32 can be caught in the receptacle 31 and difficult to take out when the shield cover 45 is opened to take out the plug 32 from the receptacle 31. Especially in the present invention, as described above, since the plug 32 is made very small, when the plug 32 is caught in the receptacle 31, it is difficult to take out.

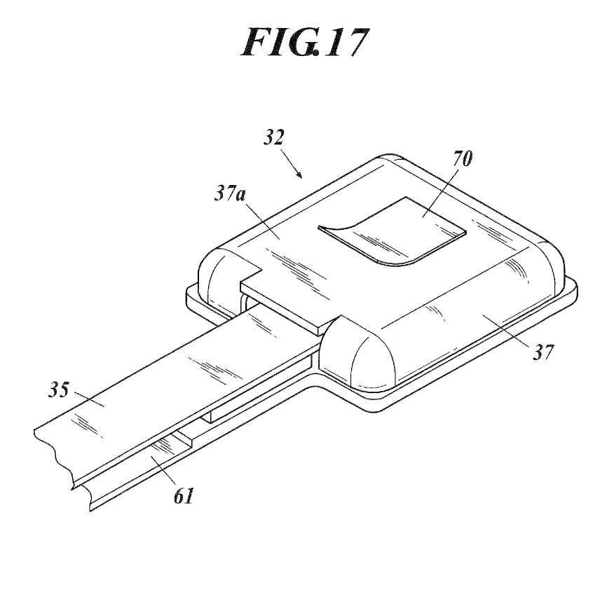

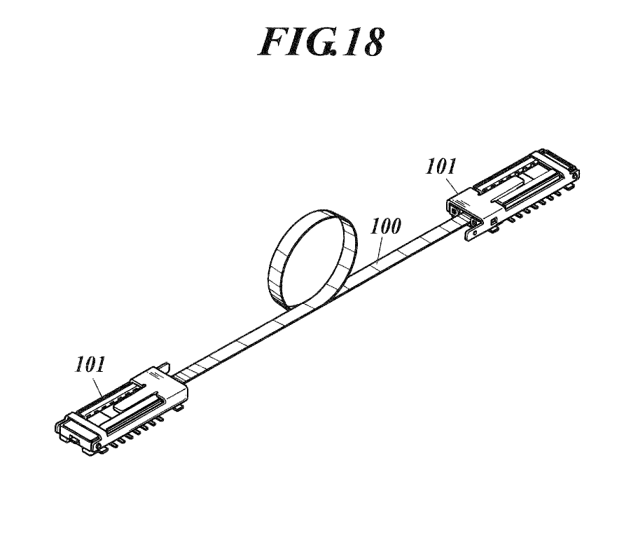

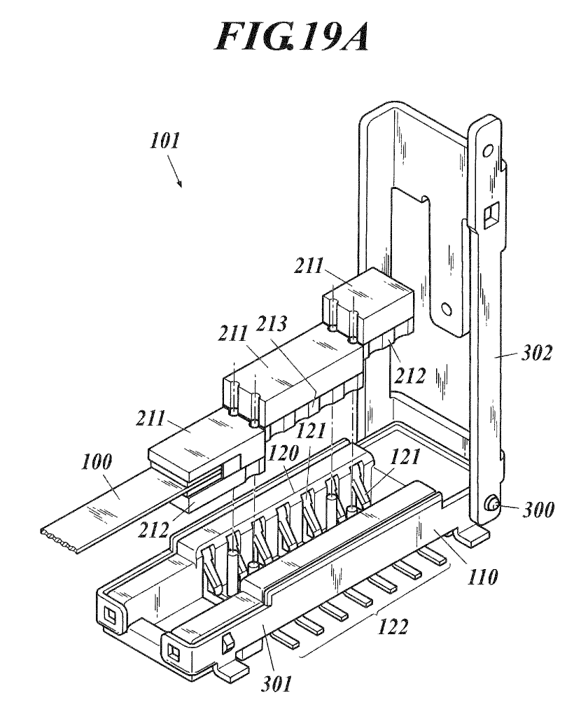

Therefore, for example, as shown in FIG. 17, it is preferable to provide a piece 70 on the top face 37a of the protective cover 37 of the plug 32, fixed to the top face 37a only on one end. The piece 70 can be composed of a metal piece, however, there is a possibility that such a piece will interfere the pressing of the protective cover 37 of the plug 32 by the elastic holding sections 53 and 53 of the shield cover 45 from the above, therefore, it is preferable that the piece 70 is formed by, for example, a tape-like material with flexibility. Also, it is more preferable if the piece 70 is placed so as to avoid the above described elastic holding sections 53 and 53.

As described above, by providing a piece 70, the fitting of the plug 32 and the receptacle 31 can be released by pulling the piece 70 and the plug 32 can be easily taken out from the receptacle 31.

Also, for example, thin coaxial cables bundled or aligned on a plane can be used instead of the film cable 6 of the connector 1 of the first embodiment or the FPC 61 for electrical signal transmission of the connector 60 (optical-electrical transmission module 60) of the third embodiment.

According to an aspect of the preferred embodiments of the present invention there is provided a connector, including:

a receptacle including a projecting terminal electrically connected to an external terminal; and

a plug including a contact point with an elastic section to elastically deform when the projecting terminal is inserted therein to be electrically connected to the projecting terminal by resilience.

Preferably, in the connector, the projecting terminal is formed substantially in an L-shape integrally with the external terminal and a width of the projecting terminal is formed even.

Preferably, in the connector, the plug includes a circuit substrate provided with the contact point.

Preferably, in the connector, a thickness of the elastic section of the contact point is formed thinner than a thickness of other portion of the circuit substrate.

Preferably, in the connector, the circuit substrate is composed of a flexible printed circuit.

Preferably, in the connector, the elastic section of the contact point includes:

an insulating layer having elasticity; and

a metal layer for electrical connection provided on a side facing the projecting terminal of the insulating layer, wherein

the elastic section is provided extending in a direction orthogonal to an inserting direction of the projecting terminal;

the insulating layer and the metal layer elastically deform in the inserting direction when the projecting terminal is inserted; and

the metal layer is brought into contact by pressure with the projecting terminal by the resilience of the insulating layer.

Preferably, in the connector, a part or a whole of the metal layer is formed by electrolytic plating.

Preferably, in the connector, the contact point includes a hole parted in a substantial H-shape by the elastic sections formed to be two tongue piece shapes each tip section of which faces each other.

Preferably, in the connector, the tip sections of the elastic sections formed to be the two tongue piece shapes are formed substantially parallel to each other.

Preferably, in the connector, a plurality of portions of the tip sections of the elastic sections formed to be the two tongue piece shapes are formed in a saw-toothed shape projecting toward each other.

Preferably, in the connector, the tip sections of the elastic sections formed to be the two tongue piece shapes are formed curved in advance to the inserting direction of the projecting terminal.

Preferably, in the connector, the receptacle includes a shield case and a shield cover including a metal material.

Preferably, in the connector, an elastic holding section is provided on the shield cover to press the plug toward the side of the projecting terminal of the receptacle.

Preferably, in the connector, a grounding projection section in contact with the shield case is provided on the shield cover.

Preferably, the connector further comprises a lock mechanism to lock the shield cover to the shield case by latching a latching projection section provided on the shield case to a latching hole provided on the shield cover.

Preferably, the connector further comprises a hinge section including:

a hole provided on the shield case; and

a latching section provided on the shield cover, wherein

the shield cover is openable and closable with respect to the shield case with the latching section latched to the hole.

Preferably, in the connector, the plug includes a circuit substrate provided with the contact point, and a film cable electrically connected to the circuit substrate.

Preferably, in the connector, a torsion preventing member including rigidity provided with an opening at a position corresponding to the contact point is mounted to the circuit substrate.

Preferably, in the connector, a wrong insertion prevention mechanism is provided on the circuit substrate to prevent wrong insertion when the circuit substrate is mounted to the receptacle.

Preferably, in the connector, the plug includes:

a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film.

Preferably, the connector further comprises an FPC for electrical signal transmission.

Preferably, in the connector, the FPC for electrical signal transmission is formed thinner than the circuit substrate.

According to an aspect of the preferred embodiments of the present invention there is provided an optical transmission module including the connector including:

a receptacle including a projecting terminal electrically connected to an external terminal; and

a plug including a contact point with an elastic section to elastically deform when the projecting terminal is inserted therein to be electrically connected to the projecting terminal by resilience, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film.

According to an aspect of the preferred embodiments of the present invention there is provided an optical-electrical transmission module including the connector including:

a receptacle including a projecting terminal electrically connected to an external terminal;

a plug including a contact point with an elastic section to elastically deform when the projecting terminal is inserted therein to be electrically connected to the projecting terminal by resilience; and

an FPC for electrical signal transmission, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film.

According to an aspect of the preferred embodiments of the present invention there is provided an optical-electrical transmission module including the connector including:

a receptacle including a projecting terminal electrically connected to an external terminal;

a plug including a contact point with an elastic section to elastically deform when the projecting terminal is inserted therein to be electrically connected to the projecting terminal by resilience; and

an FPC for electrical signal transmission, wherein

the plug includes a circuit substrate provided with the contact point;

a wiring to electrically connect the contact point and an electronic component;

an optical transmission waveguide film; and

an optical signal sending and receiving section to convert an optical signal transmitted through the optical transmission waveguide film to an electrical signal and to convert an electrical signal output from the electronic component to an optical signal to output to the optical transmission waveguide film, and

the FPC for electrical signal transmission is formed thinner than the circuit substrate.

According to these aspects, when the projecting terminal provided on the receptacle is inserted in the contact point of the plug, the elastic section is brought into contact by pressure with the projecting terminal by the resilience due to the elastic deformation of the elastic section of the contact point to automatically and reliably connect the contact point and the projecting terminal electrically. Therefore, a mechanism to obtain the electrical connection between the projecting terminal and the contact point of the plug does not need to be newly provided. Also, each contact point of the plug and each projecting terminal can be formed in a compact form in an order of several tens of μm to several hundreds of μm where adequate and reliable electrical connection can be obtained and maintained and the entire connector can be made smaller.

The projecting terminal is projected from the receptacle to a degree where electrical connection with the contact point of the plug is secured, and in this case, the electrical connection can be secured and maintained adequately when projected in an order of several tens of μm to several hundreds of μm. Therefore, the thickness of the receptacle and the plug can be formed adequately thin. Consequently, the thickness of the entire connector can be made shorter in height to about 1 mm.

The entire disclosure of Japanese Patent Application No. 2008-038596 filed on Feb. 20, 2008 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A connector, comprising:
a receptacle including a projecting terminal electrically connected to an external terminal; and
a plug including a contact point with an elastic section to elastically deform when the projecting terminal is inserted therein to be electrically connected to the projecting terminal by resilience.

2. The connector according to claim 1, wherein the projecting terminal is formed substantially in an L-shape integrally with the external terminal and a width of the projecting terminal is formed even.

3. The connector according to claim 1, wherein the plug includes a circuit substrate provided with the contact point.

4. The connector according to claim 3, wherein a thickness of the elastic section of the contact point is formed thinner than a thickness of other portion of the circuit substrate.

5. The connector according to claim 3, wherein the circuit substrate is composed of a flexible printed circuit.

6. The connector according to claim 1, wherein the elastic section of the contact point includes:
an insulating layer having elasticity; and
a metal layer for electrical connection provided on a side facing the projecting terminal of the insulating layer, wherein
the elastic section is provided extending in a direction orthogonal to an inserting direction of the projecting terminal;
the insulating layer and the metal layer elastically deform in the inserting direction when the projecting terminal is inserted; and
the metal layer is brought into contact by pressure with the projecting terminal by the resilience of the insulating layer.

7. The connector according to claim 6, wherein a part or a whole of the metal layer is formed by electrolytic plating.

8. The connector according to claim 6, wherein the contact point includes a hole parted in a substantial H-shape by the elastic sections formed to be two tongue piece shapes each tip section of which faces each other.

9. The connector according to claim 8, wherein the tip sections of the elastic sections formed to be the two tongue piece shapes are formed substantially parallel to each other.

10. The connector according to claim 8, wherein a plurality of portions of the tip sections of the elastic sections formed to be the two tongue piece shapes are formed in a saw-toothed shape projecting toward each other.

11. The connector according to claim 8, wherein the tip sections of the elastic sections formed to be the two tongue piece shapes are formed curved in advance to the inserting direction of the projecting terminal.

12. The connector according to claim 1, wherein the receptacle includes a shield case and a shield cover including a metal material.

13. The connector according to claim 12, wherein an elastic holding section is provided on the shield cover to press the plug toward the side of the projecting terminal of the receptacle.

14. The connector according to claim 12, wherein a grounding projection section in contact with the shield case is provided on the shield cover.

15. The connector according to claim 12, further comprising a lock mechanism to lock the shield cover to the shield case by latching a latching projection section provided on the shield case to a latching hole provided on the shield cover.

16. The connector according to claim 12, further comprising a hinge section including:
a hole provided on the shield case; and
a latching section provided on the shield cover, wherein
the shield cover is openable and closable with respect to the shield case with the latching section latched to the hole.

17. The connector according to claim 1, wherein the plug includes a circuit substrate provided with the contact point, and a film cable electrically connected to the circuit substrate.

18. The connector according to claim 17, wherein a torsion preventing member including rigidity provided with an opening at a position corresponding to the contact point is mounted to the circuit substrate.

19. The connector according to claim 17, wherein a wrong insertion prevention mechanism is provided on the circuit substrate to prevent wrong insertion when the circuit substrate is mounted to the receptacle.

20. The connector according to claim 1, wherein the plug includes:
a circuit substrate provided with the contact point;
a wiring to electrically connect the contact point and an electronic component;
an optical transmission waveguide film; and
an optical signal sending and receiving section to convert an optical signal transmitted through the optical transmission waveguide film to an electrical signal and to convert an electrical signal output from the electronic component to an optical signal to output to the optical transmission waveguide film.

21. The connector according to claim 20 further comprising an FPC for electrical signal transmission.

22. The connector according to claim 21, wherein the FPC for electrical signal transmission is formed thinner than the circuit substrate.

23. An optical transmission module comprising the connector according to claim 20.

24. An optical-electrical transmission module comprising the connector of claim 21.

25. An optical-electrical transmission module comprising the connector of claim 22.
